(19) United States
(12) Patent Application Publication
(10) Pub. No.: US 2013/0160548 A1
(43) Pub. Date: Jun. 27, 2013

(54) INERTIAL FORCE SENSOR

(71) Applicants: Takami Ishida, Osaka (JP); Tsuyoshi Fujii, Osaka (JP)

(72) Inventors: Takami Ishida, Osaka (JP); Tsuyoshi Fujii, Osaka (JP)

(73) Assignee: PANASONIC CORPORATION, Osaka (JP)

(21) Appl. No.: 13/822,244

(22) PCT Filed: Nov. 7, 2011
(86) PCT No.: PCT/JP2011/006184

§ 371 Date: Mar. 11, 2013

(30) Foreign Application Priority Data
Nov. 18, 2010 (JP) 2010-257796

(51) Int. Cl. G01P 15/10

(52) U.S. Cl. CPC G01P 15/10
USPC 73/514.29

(57) ABSTRACT

An inertial force sensor includes a substrate, a transducer disposed on the substrate, and a wiring trace disposed on the substrate and connected with the transducer. The wiring trace includes a lower electrode layer on the substrate, a piezoelectric layer on the lower electrode layer, a capacitance-reducing layer on the piezoelectric layer, and an upper electrode layer on the capacitance-reducing layer. The capacitance-reducing layer has a relative dielectric constant smaller than that of the first piezoelectric layer. This inertial force sensor can improve a noise level.

### TECHNICAL FIELD

The present invention relates to an inertial force sensor for detecting, e.g. acceleration or angular velocity, and adapted for use in, e.g. portable terminals and automobiles.

### BACKGROUND ART

FIG. 11 is a cross-sectional view of conventional inertial force sensor 1. Inertial force sensor 1 includes substrate 2, lower electrode layer 3 provided on substrate 2, piezoelectric layer 4 provided on lower electrode layer 3, and upper electrode layer 5 provided on piezoelectric layer 4.

Inertial force sensor 1 may have a large noise level, and increase power consumption of a circuit to be connected with inertial force sensor 1.

An inertial force sensor similar to inertial force sensor 1 is disclosed in Patent Literature 1.

### CITATION LIST

### Patent Literature

Patent Literature 1: Japanese Patent Laid-Open Publication No. 2008-224628

### SUMMARY

An inertial force sensor includes a substrate, a transducer disposed on the substrate, and a wiring trace disposed on the substrate and connected with the transducer. The wiring trace includes a lower electrode layer on the substrate, a piezoelectric layer on the lower electrode layer, a capacitance-reducing layer on the piezoelectric layer, and an upper electrode layer on the capacitance-reducing layer. The capacitance-reducing layer has a relative dielectric constant smaller than that of the first piezoelectric layer.

This inertial force sensor can improve a noise level.

### BRIEF DESCRIPTION OF DRAWINGS

FIG. 1A is a cross-sectional view of an inertial force sensor according to

Exemplary Embodiment 1 of the present invention.

FIG. 1B is a cross-sectional view of another inertial force sensor according to Embodiment 1.

FIG. 2A is a flow chart illustrating processes for manufacturing the inertial force sensor according to Embodiment 1.

FIG. 2B is a flow chart illustrating processes for manufacturing a comparative example of an inertial force sensor.

FIG. 3 is a top view of still another inertial force sensor according to Embodiment 1.

FIG. 4A is a cross-sectional view of the inertial force sensor at lines 4A-4A shown in FIG. 3.

FIG. 4B is a cross-sectional view of the inertial force sensor at line 4B-4B shown in FIG. 3.

FIG. 5A is an SEM photograph showing a cross section the inertial force sensor at line 5A-5A shown in FIG. 3.

FIG. 5B is an SEM photograph showing a cross section of the comparative example of the inertial force sensor.

FIG. 6 is a cross-sectional view of a further inertial force sensor according to Embodiment 1.

FIG. 7 is a top view of a further inertial force sensor according to Embodiment 1.

FIG. 8A is a cross-sectional view of the inertial force sensor at line 8A-8A shown in FIG. 7.

FIG. 8B is a cross-sectional view of the inertial force sensor at line 8B-8B shown in FIG. 7.

FIG. 9 is a top view of an inertial force sensor according to Exemplary Embodiment 2 of the invention.

FIG. 10 is a top view of an inertial force sensor according to Exemplary Embodiment 3 of the invention.

FIG. 11 is a cross-sectional view of a conventional inertial force sensor.

### DETAIL DESCRIPTION OF PREFERRED EMBODIMENTS

### Exemplary Embodiment 1

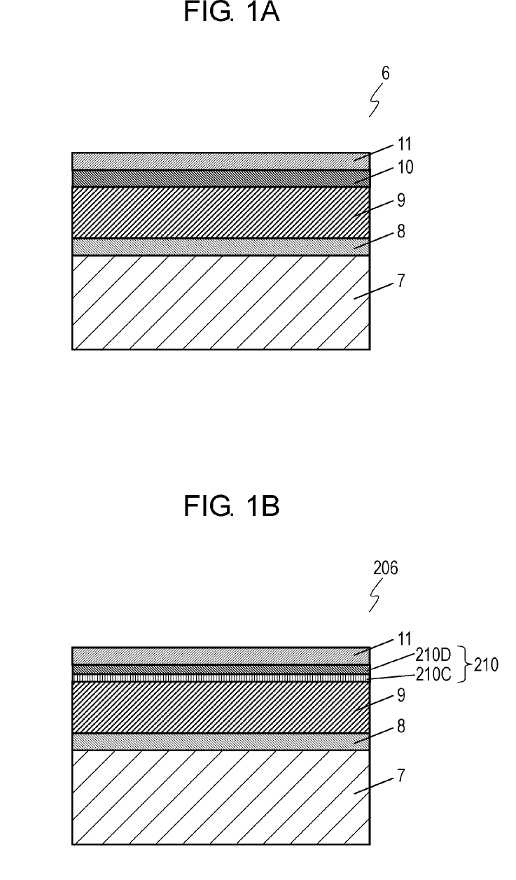

FIG. 1A is a cross-sectional view of inertial force sensor 6 according to Exemplary Embodiment 1 of the present invention. Inertial force sensor 6 for detecting an inertial force, such as acceleration or angular velocity has a region where wiring traces are formed. This region includes substrate 7, lower electrode layer 8 disposed on an upper surface of substrate 7, piezoelectric layer 9 disposed on an upper surface of lower electrode layer 8, capacitance-reducing layer 10 disposed on an upper surface of piezoelectric layer 9, and upper electrode layer 11 disposed on an upper surface of capacitance-reducing layer 10. Capacitance-reducing layer 10 has a relative dielectric constant smaller than a relative dielectric constant of piezoelectric layer 9.

This structure reduces a capacitance between lower electrode layer 8 and upper electrode layer 11, thereby reducing a noise level of inertial force sensor 6 and improves its sensibility. In addition, it can reduce power consumption of a circuit connected to inertial force sensor 6.

Structural elements will be described below.

Substrate 7 is made of a semiconductor material, such as silicon (Si), or a non-piezoelectric material, such as fused silica or alumina. The substrate maybe made of silicon to allow inertial force sensor 6 to have a small size by a micro-processing technique. Substrate 7 may include other layers, such as a barrier layer made of silicon dioxide film (SiO₂) or a bonding layer made of titanium (Ti), disposed on a surface of the substrate.

Lower electrode layer 8 is made of, for example, a single metal, such as copper, silver, gold, titanium, tungsten, platinum, chromium, or molybdenum, an alloy mainly containing at least one of these metals, or a laminated material of at least one of these metals. Lower electrode layer 8 may be preferably made of platinum (Pt) mixed with Ti or TiOx to have high conductivity and excellent stability in a high-temperature oxidizing atmosphere. According to Embodiment 1, lower electrode layer 8 has a thickness ranging from 100 nm to 500 nm.

Piezoelectric layer 9 is made of a piezoelectric material, such as zinc oxide, lithium tantalate, lithium niobate, or potassium niobate. Piezoelectric layer 9 may be preferably made of lead zirconate titanate (Pb(Zr,Ti)O₃) to provide inertial force sensor 6 with superior piezoelectric characteristics. According to Embodiment 1, piezoelectric layer 9 has a thickness ranging from 1000 nm to 4000 nm. Piezoelectric layer 9 may include another layer, such as an orientation control layer made of titanate (PbTiO₃), provided at the lower surface thereof. Such a layer is disposed on the upper surface of lower electrode layer 8.

Capacitance-reducing layer 10 has an insulating property and is made of a material suitable for film formation by a low temperature processing and capable of reducing damages to piezoelectric layer 9 in the process of patterning. Capacitance-reducing layer 10 may be made of an organic material, such as polyimide, having a low dielectric constant. Photosensitive polyimide out of organic materials having low dielectric constants allows capacitance-reducing layer 10 to be processed easily and to have high resistance to chemicals.

Capacitance-reducing layer 10 may be made of an alkali developing type photosensitive polyimide which can be developed with alkaline developing solution. The alkali developing type photosensitive polyimide can be patterned by alkali development, and hence, does not produce an acid in a chemical reaction in the process of patterning (i.e., developing process) to affect piezoelectric layer 9, thus preventing piezoelectric layer 9 from being damaged.

Capacitance-reducing layer 10 may be made of an inorganic material, such as SiO₂, SiN, SiON, SiC, Al₂O₃, having a relative dielectric constant lower than that of piezoelectric layer 9. Capacitance-reducing layer 10 made of SiO₂ or SiN has outstanding durability, such as resistance to or resistance to moisture. According to the Embodiment 1, capacitance-reducing layer 10 has a thickness ranging from 100 nm to 2000 nm.

Upper electrode layer 11 is made of, for example, a single metal, such as copper, silver, gold, titanium, tungsten, platinum, chromium, or molybdenum, an alloy mainly containing at least one of these metals, or a laminated material of at least one of these metals. Upper electrode layer 11 may be preferably made of gold (Au) to have high resistance to most of chemical corrosion such as heat, moisture, and oxygen. According to Embodiment 1, upper electrode layer 11 has a thickness ranging from 100 nm to 2000 nm. Upper electrode layer 11 may include another layer, such as a bonding layer made of titanium (Ti), provided at a lower surface thereof. Such a layer is disposed on the upper surface of capacitance-reducing layer 10.

FIG. 1B is a cross-sectional view of another inertial force sensor 206 according to Embodiment 1. In FIG. 1B, components identical to those of to inertial force sensor 6 shown in FIG. 1A are denoted by the same reference numerals. Inertial force sensor 206 includes capacitance-reducing layer 210 disposed on an upper surface of piezoelectric layer 9 instead of capacitance-reducing layer 10 of inertial force sensor 6 shown in FIG. 1A. Upper electrode layer 11 is disposed on an upper surface of capacitance-reducing layer 210. Capacitance-reducing layer 210 includes organic material layer 210C and inorganic material layer 210D disposed on an upper surface of organic material layer 210C. Organic material layer 210C is made of the organic material having a low dielectric constant discussed with reference to capacitance-reducing layer 10. Inorganic material layer 210D is made of the above-discussed inorganic material. Organic material layer 210C and inorganic material layer 210D are preferably made of photosensitive polyimide and SiN, respectively. These materials provide capacitance-reducing layer 210 with outstanding durability, such as resistance to chemical and resistance to moisture while minimizing damages to piezoelectric layer 9 in the process of patterning.

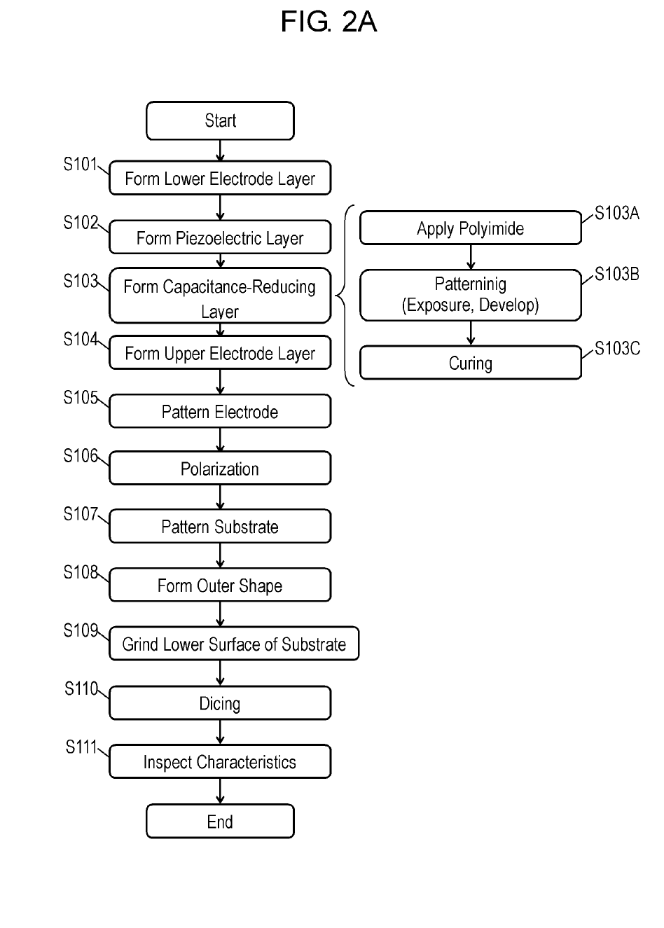

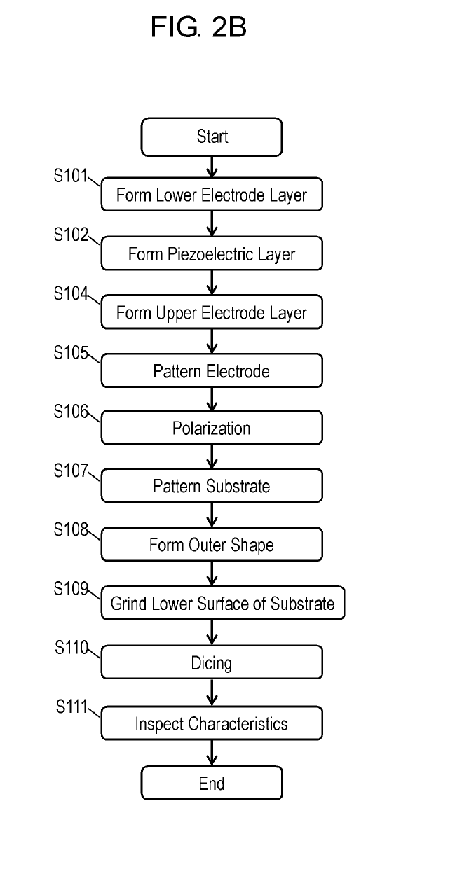

FIG. 2A is a flow chart illustrating processes for manufacturing inertial force sensor 6 according to Embodiment 1. A method of manufacturing inertial force sensor 6 will be described below with reference to FIG. 2A.

Lower electrode layer 8 is formed on an upper surface of a wafer that becomes substrate 7 (Step S101). Next, piezoelectric layer 9 is formed on an upper surface of lower electrode layer 8 (Step S102). Capacitance-reducing layer 10 is then formed on an upper surface of piezoelectric layer 9 (Step S103).

A method of forming capacitance-reducing layer 10 at Step S103 will be described below. Material, such as polyimide, is applied onto the upper surface of piezoelectric layer 9 (Step S103A). Next, the applied material is patterned (Step S103B). Subsequently, the patterned material is subjected to a curing process (Step S103C) to harden, thus providing capacitance-reducing layer 10.

Next, upper electrode layer 11 is formed on the upper surface of capacitance-reducing layer 10 (Step S104), and upper electrode layer 11 is then subjected to a process of patterning (Step S105). Then, a voltage is applied between upper electrode layer 11 and lower electrode layer 8 to polarize piezoelectric layer 9 (Step S106). After that, the wafer (substrate 7), lower electrode layer 8, and piezoelectric layer 9 are patterned (Step S107) to form an outer shape of inertial force sensor 6 (Step S108). Next, the lower surface of the wafer (substrate 7) is ground to make substrate 7 have a predetermined thickness (Step S109), and the wafer is divided into individual substrate 7 by a process of dicing to obtain individual inertial force sensors 6 (Step S110). Subsequently, inertial force sensors 6 obtained in the Step S110 are inspected in their characteristics to obtain inertial force sensors 6 (Step S111).

FIG. 2B is a flow chart illustrating processes for manufacturing conventional inertial force sensor 1 as a comparison example shown in FIG. 11 which does not include a capacitance-reducing layer. In FIG. 2B, manufacturing processes identical to those of inertial force sensor 6 according to Embodiment 1 shown in FIG. 2A are denoted by the same reference numerals. Conventional inertial force sensor 1 includes upper electrode layer 5 on an upper surface of piezoelectric layer 4. The manufacturing processes of inertial force sensor 6 according to Embodiment 1 includes a film-forming process for forming capacitance-reducing layer 10 (Step S103) which is executed between the film-forming process of forming piezoelectric layer 9 (Step S102) and the film-forming process of forming upper electrode layer 11 (Step S104), as shown in FIGS. 2A and 2B.

According to embodiment 1, capacitance-reducing layer 10 is made of a photosensitive polyimide containing diazonaphthoquinone (DNQ) as a photosensitizer. Diazonaphthoquinone is widely used as a photosensitizer of positive resist, and capable of making alkali development that uses an alkaline developing solution for development. As discussed above, capacitance-reducing layer 10 is made preferably of an alkali developing type photosensitive polyimide. When the alkali developing type photosensitive polyimide is exposed to light irradiated through a mask having a given pattern drawn thereon, the diazonaphthoquinone, the photosensitizing substance changes into indene carboxylic acid via indene ketene as a result of photochemical reaction (photo-polymerization reaction) by the light exposure. Since indene carboxylic acid has high solubility in the alkaline solution, portions of the polymer irradiated with the light dissolve while the other portions of the polymer not exposed to the light remain unchanged, thereby patterning the alkali developing type photosensitive polyimide. In addition, diazonaphthoquinone acts as a dissolution inhibitor of the polymer. A heat treatment, i.e., a process of curing, being performed to the patterned alkali developing type photosensitive polyimide promotes an imidization reaction (dehydrative cyclization) of polyamide acid (polyamic acid), which is a polyimide precursor, to harden the polyimide. In this process, the polyamide acid dissolves in an organic solvent, but it does not dissolve in the organic solvent when it becomes polyimide. Therefore, the polyamide acid is applied in a form of solution combined with the organic solvent containing a photosensitizer before the patterning. The applied solution is dried by pre-baking and patterned in a desired pattern formed by the processes of exposure and development, and then, the heat treatment, the process of curing, is performed to the applied polyamide solution to obtain a patterned polyimide layer.

The photosensitive polyimide having a low curing temperature, i.e., the temperature in the process of curing for capacitance-reducing layer 10, can reduce damages to piezoelectric layer 9. In the case that lead zirconate titanate is used for piezoelectric layer 9, for instance, the piezoelectric characteristic of piezoelectric layer 9 is eliminated to cause piezoelectric layer 9 to becomes a paraelectric layer if a thermal stress higher than its Curie temperature is applied to the layer since the Curie temperature of the lead zirconate titanate is about 330° C. Capacitance-reducing layer 10 made of the photosensitive polyimide having a curing temperature lower than the

Curie temperature of piezoelectric layer 9 reduces such damages given to piezoelectric layer 9 during the curing process.

Capacitance-reducing layer 10 according to Embodiment 1 is made of the photosensitive polyimide containing diazonaphthoquinone as the photosensitizer. Capacitance-reducing layer 10 may be made of another photosensitive polyimide containing with another photosensitizer that has the same properties.

A difference of the capacitance between the upper electrode layer and the lower electrode layer of an example of inertial force sensor 6 including capacitance-reducing layer 10 according to Embodiment 1 from a comparative example of an inertial force sensor not including capacitance-reducing layer 10.

Piezoelectric layer 9 has a relative dielectric constant εr of 980, a thickness d of 2.85 μm, and a dielectric constant ε of 8.68×10⁻⁹ (F/m).

The alkali developing type photosensitive polyimide that is the material of capacitance-reducing layer 10 of the example has a relative dielectric constant εr of 3, a thickness d of 0.5 μm, and a dielectric constant εof 2.66×10⁻¹¹ (F/m).

Inertial force sensor 6 of the example including capacitance-reducing layer 10 has capacitance C_{Total} between upper electrode layer 11 and lower electrode layer 8 is a combined capacitance formed by a part constituted by piezoelectric layer 9 and another part constituted by capacitance-reducing layer 10. Capacitance C_{PE} and capacitance C_{PI} which are formed by piezoelectric layer 9 and capacitance-reducing layer 10 respectively provide capacitance C_{Total} expressed as follows:

C_{Total}=C_{PE}×C_{PI}/(C_{PE}+C_{PI})

Since the relative dielectric constant of capacitance-reducing layer 10 is only about 0.3% of the relative dielectric constant of piezoelectric layer 9, capacitance C_{Total} becomes close to capacitance C_{PE} formed by only the portion constituted by capacitance-reducing layer 10 when these two layers form the combined capacitance even if there is a certain difference in their thicknesses. If the thickness of capacitance-reducing layer 10 is ⅕ of the thickness of piezoelectric layer 9, for instance, capacitance C_{Total} is about 1% of capacitance C_{PE} constituted by only piezoelectric layer 9. As discussed above, the capacitance between upper electrode layer 11 and lower electrode layer 8 can be reduced substantially by capacitance-reducing layer 10 made of the material having a low dielectric constant provided between upper electrode layer 11 and piezoelectric layer 9.

Samples were prepared and evaluated to confirm the capacitance-reducing effect of capacitance-reducing layer 10. Specifically, a sample according to this embodiment was prepared by forming an alkali developing type photosensitive polyimide to have a thickness of 1.6 μm as capacitance-reducing layer 10 on piezoelectric layer 9 having a thickness of 2.85 μm, and forming upper electrode layer 11 on the piezoelectric layer. Upper electrode layer 11 includes a Ti layer having a thickness of 10 nm provided on capacitance-reducing layer 10 and an Au layer having a thickness of 300 nm provided on the Ti layer. A comparative sample having the same structure as the sample of this embodiment except that capacitance-reducing layer 10 is not included.

The capacitance of the comparative sample not including capacitance-reducing layer 10 was 1887.0 pF, while the capacitance of the embodiment sample including capacitance-reducing layer 10 was 16.9 pF. Thus, the capacitance of the embodiment sample including capacitance-reducing layer 10 was 0.9% of the capacitance of the comparative sample not including capacitance-reducing layer 10, thus having confirming the capacitance-reducing effect as estimated from the above formula.

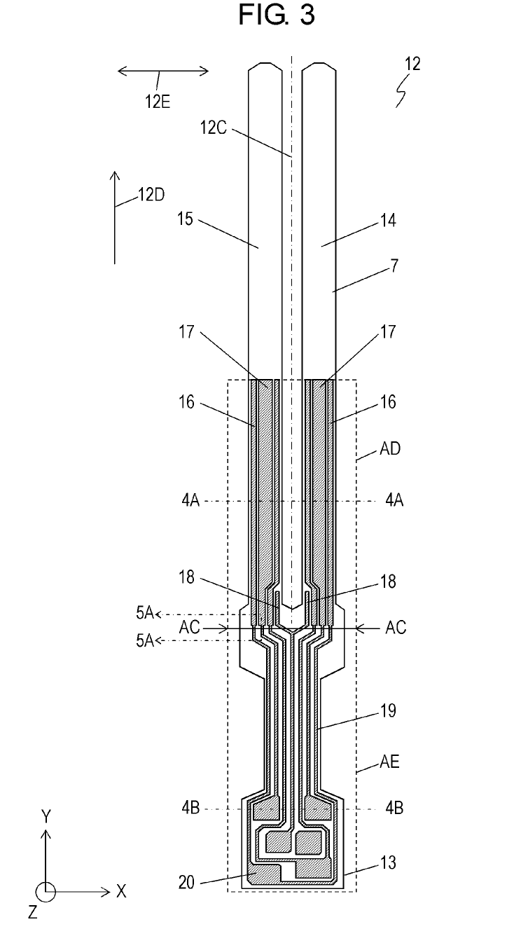

FIG. 3 is a top view of still another inertial force sensor 12 according to Embodiment 1. In FIG. 3, components identical to those of inertial force sensor 6 shown in FIG. 1A are denoted by the same reference numerals. Inertial force sensor 12 includes substrate 7, driving electrode 16, detection electrode 17, monitor electrode 18, wiring trace 19, and electrode pad 20. Driving electrode 16, detection electrode 17, monitor electrode 18, wiring trace 19, and electrode pad 20 are disposed on an upper surface of substrate 7. Substrate 7 is made of a silicon plate, and has a shape of tuning fork including support portion 13 and two arms 14 and 15 extending in parallel to each other from support portion 13 in direction 12D along center axis 12C. Arms 14 and 15 are arranged opposite to each other with respect to the center axis 12C and at both sides along the axis 12E perpendicular to the center axis 12C. Arms 14 and 15 vibrate at a natural resonance frequency. Detection electrode 17 is disposed substantially on a center region of each of arms 14 and 15 along the direction of axis 12E. Driving electrodes 16 are disposed at both sides of detection electrode 17 in the direction of axis 12E. Monitor electrodes 18 are disposed at base portions of arms 14 and 15 connected to support portion 13. Driving electrodes 16, detection electrodes 17, and monitor electrodes 18 are electrically connected with respective electrode pads 20 via wiring traces 19. Inertial force sensor 12 is configured to have an angular velocity about the center axis 12C thereof applied thereto, thus functioning as an angular velocity sensor for detecting the angular velocity.

An operation of inertial force sensor 12 will be described below. As shown in FIG. 3, a Y-axis and an X-axis parallel to the center axis 12C and the axis 12E respectively, are defined while a Z-axis perpendicular to both the X-axis and Y-axis. Driving electrodes 16 and monitor electrodes 18 are connected to electrode pads 20 via wiring traces 19. Electrode pads 20 are configured to be connected with a drive circuit. Detection electrodes 17 are connected with electrode pads 20 via wiring traces 19. Electrode pads 20 are configured to be connected with a detection circuit. Driving electrodes 16 and monitor electrodes 18 are connected with the drive circuit, so that driving electrodes 16, monitor electrodes 18, and the drive circuit constitute a driving loop to drive inertial force sensor 12 and vibrate arms 14 and 15. Arms 14 and 15 are configured to vibrate at the natural resonance frequency. Arms 14 and 15 vibrate in the direction of the X-axis when a driving signal having an alternating-current (AC) voltage having the resonance frequency is applied from the drive circuit to driving electrodes 16 via electrode pads 20 and wiring traces 19. Monitor electrodes 18 send a monitor signal corresponding to these vibrations to the drive circuit. The drive circuit controls the driving signal according to the monitor signal such that arms 14 and 15 vibrate at constant amplitude in the direction of the X-axis at the resonance frequency. When an angular velocity about the Y-axis is applied to inertial force sensor 12 under this condition, arms 14 and 15 warp in the direction of the Z-axis due to a Coriolis force generated in arms 14 and 15 corresponding to the angular velocity, and an electric charge is generated in detection electrodes 17. The generated electric charge produces an electric current as a detection signal generated in detection electrodes 17 is sent to the detection circuit via wiring traces 19 and electrode pads 20. The detection circuit can detect the angular velocity based on the detection signal.

As described above, detection electrodes 17 are transducers that convert a mechanical distortion and a deformation produced in arms 14 and 15 due to the Coriolis force into electric signals. Driving electrodes 16 are transducers that mechanically deform and vibrate arms 14 and 15 according to an electric signal of the AC voltage applied thereto. Monitor electrodes 18 are transducers that outputs electric signals corresponding to the mechanical vibration of arms 14 and 15.

Inertial force sensor 12 has regions AD and AE separated by dividing line AC. Region AD has at least detection electrodes 17 formed therein. Region AE has at least wiring traces 19 formed therein. The capacitance of the region having capacitance-reducing layer 10 provided therein degrades the piezoelectric characteristic of that region. Therefore, capacitance-reducing layer 10 is not provided in region AD having detection electrodes 17 provided therein while capacitance-reducing layer 10 is provided in region AE having wiring traces 19 provided therein. This structure can ensure the piezoelectric characteristic of region AD having detection electrodes 17 formed therein while reducing noise generated in region AE having wiring traces 19 formed therein.

In inertial force sensor 12 according to Embodiment 1, driving electrodes 16 are formed in region AD. This arrangement avoids a decrease in driving efficiency attributable to capacitance-reducing layer 10. Monitor electrodes 18 are formed in region AD. This arrangement ensures the monitor signal having sufficient amplitude being input to the drive circuit from monitor electrodes 18.

In inertial force sensor 12 according to Embodiment 1, electrode pads 20 are formed in region AE. This arrangement can reduce noise generated in electrode pads 20.

Capacitance-reducing layer 10 may be provided also in a region, such as the tip ends of arms 14 and 15, having none of driving electrodes 16, detection electrodes 17, and monitor electrodes 18 provided therein. This arrangement can increase the mass of arms 14 and 15, accordingly improving the sensibility of inertial force sensor 12.

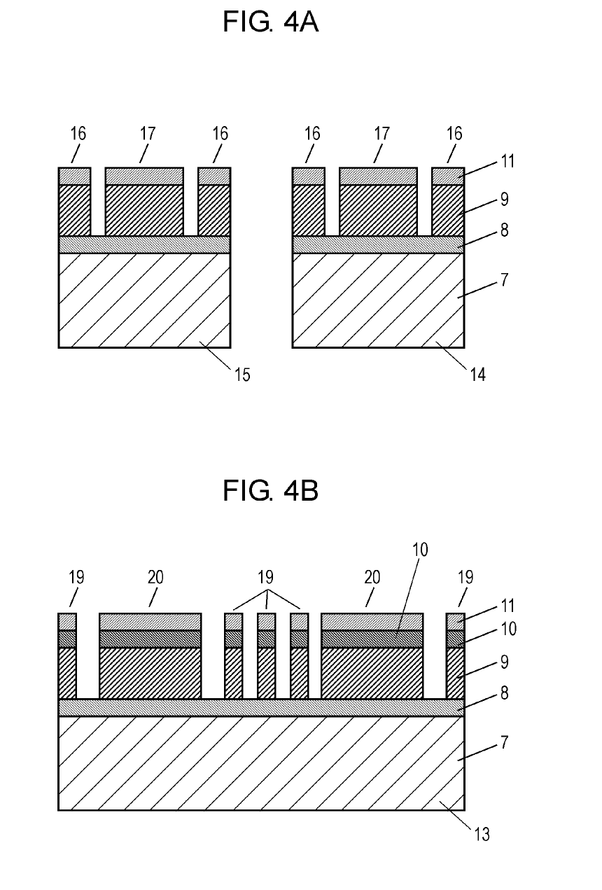

FIG. 4A is a cross-sectional view of region AD of inertial force sensor 12 at line 4A-4A shown in FIG. 3. In region AD, inertial force sensor 12 includes substrate 7 that are each of arms 14 and 15, lower electrode layer 8 provided on the upper surface of substrate 7, piezoelectric layer 9 provided on the upper surface of lower electrode layer 8, and upper electrode layer 11 provided on the upper surface of piezoelectric layer 9. Detection electrodes 17 are disposed substantially on the center region of substrate 7 (i.e., arms 14 and 15) in the direction of the X-axis. Driving electrodes 16 are disposed individually at both sides of detection electrode 17 in the direction of the X-axis. As shown, capacitance-reducing layer 10 is not provided in region AD where driving electrodes 16 and detection electrodes 17 are provided on arms 14 and 15.

FIG. 4B is a cross-sectional view of region AE of inertial force sensor 12 at line 4B-4B shown in FIG. 3 for illustrating a cross section of support portion 13. In region AE, inertial force sensor 12 includes substrate 7 that is support portion 13, lower electrode layer 8 provided on the upper surface of substrate 7, piezoelectric layer 9 provided on the upper surface of lower electrode layer 8, capacitance-reducing layer 10 provided on the upper surface of piezoelectric layer 9, and upper electrode layer 11 provided on the upper surface of capacitance-reducing layer 10. Electrode pads 20 shown in FIG. 4B are electrically connected with detection electrodes 17. Wiring traces 19 are connected with driving electrodes 16 or monitor electrodes 18. Wiring traces 19 connected with detection electrodes 17 have a structure similar to wiring traces 19 connected with driving electrodes 16 and monitor electrodes 18. As described above, capacitance-reducing layer 10 is provided in region AE having wiring traces 19 and electrode pads 20 provided therein.

Noise may be generated due to an electric charge produced by a slight vibration produced in piezoelectric layer 9 in region AE, which does not constitute the characteristic, when inertial force sensor 12 is driven. Capacitance-reducing layer 10 can reduce the noise, and hence improve a noise level and decrease power consumption of the drive circuit and detection circuit connected with inertial force sensor 12.

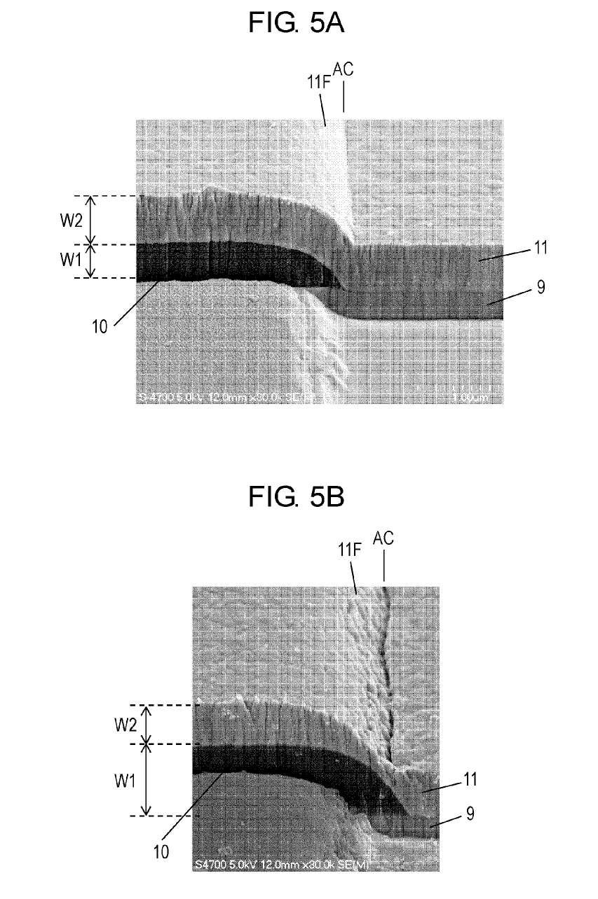

FIG. 5A is an SEM photograph of a cross section of the inertial force sensor at line 5A-5A shown in FIG. 3 captured with a scanning electron microscope (SEM). Thickness W1 of capacitance-reducing layer 10 is not larger than thickness W2 of upper electrode layer 11, and, more preferably, thickness W1 is smaller than thickness W2 of upper electrode layer 11. In this case, slope portion 11F of upper electrode layer 11 formed around boundary AC between region AD having capacitance-reducing layer 10 provided therein and region AE not having capacitance-reducing layer 10 provided therein extends continuously and smoothly. FIG. 5B is a cross-sectional view of inertial force sensor 12 at line 5B-5B shown in FIG. 3. Thickness W1 is larger than thickness W2. In this case, a crack appears in slope portion 11F of upper electrode layer 11 along boundary AC. As shown, thickness W1 of capacitance-reducing layer 10 is not larger than thickness W2 of upper electrode layer 11, thereby avoiding a crack formed in the boundary of upper electrode layer 11. However, thickness W1 of capacitance-reducing layer 10 excessively decreased may not reduce the capacitance (C_{PI}=ε·S/d, where S is the area of the facing electrode) of capacitance-reducing layer 10, and thus, may not reduce capacitance C_{Total}. Capacitance-reducing layer 10 has dielectric constant ε1 while piezoelectric layer 9 has dielectric constant ε2. In order to ensure the effect of reducing the capacitance, a lower limit of thickness W1 of capacitance-reducing layer 10 is specified such that a value ε1/W1 obtained by dividing dielectric constant ε1 of capacitance-reducing layer 10 by thickness W1 be not larger than 5% of a value ε2/W2 obtained by dividing dielectric constant ε2 of piezoelectric layer 9 by thickness W2.

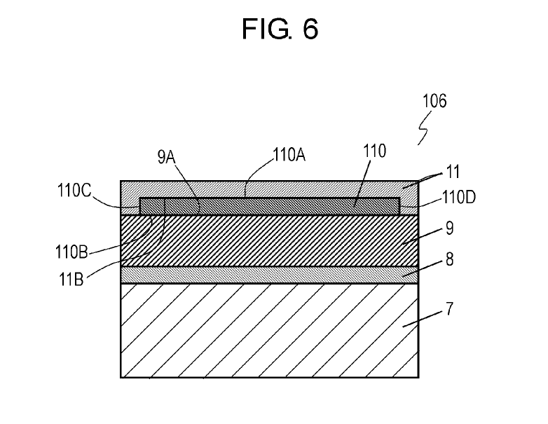

FIG. 6 is a cross-sectional view of further inertial force sensor 106 according to Embodiment 1. In FIG. 6, components identical to those of inertial force sensor 6 shown in FIG. 1 are denoted by the same reference numerals. Inertial force sensor 106 includes capacitance-reducing layer 110 made of a material similar to that of capacitance-reducing layer 10 of inertial force sensor 6 shown in FIG. 1A.

Capacitance-reducing layer 110 of inertial force sensor 106 shown in FIG. 6 has lower surface 110B situated on an upper surface 9A of piezoelectric layer 9, upper surface 110A situated on lower surface 11B of upper electrode layer 11, and side surfaces 110C and 110D opposite to each other connected with upper surface 110A and lower surface 110B. Upper electrode layer 11 covers not only upper surface 110A but also side surfaces 110C and 110D of capacitance-reducing layer 110. Thus, piezoelectric layer 9 and upper electrode layer 11 entirely cover capacitance-reducing layer 110 not to expose capacitance-reducing layer 110 from piezoelectric layer 9 and upper electrode layer 11.

In inertial force sensor 6 shown in FIG. 1A, the side surfaces of capacitance-reducing layer 10 are exposed from piezoelectric layer 9 and upper electrode layer 11. This structure protects capacitance-reducing layer 10 in processes at and after Step S104 for manufacturing inertial force sensor 6 shown in FIG. 2A. At the Step S107, for instance, piezoelectric layer 9, lower electrode layer 8, and substrate 7 are etched with an etchant, such as etching solution or etching gas, when these layers are patterned.

The side surfaces of capacitance-reducing layer 10 are damaged by the etchant if being exposed during the process of etching, hence degrading its characteristics and adhesion to piezoelectric layer 9 and upper electrode layer 11.

In inertial force sensor 106 shown in FIG. 6, capacitance-reducing layer 110 is not damaged even by the etchant used in the Step S107 shown in FIG. 2A since side surfaces 110C and 110D of capacitance-reducing layer 110 are covered by upper electrode layer 11 such that capacitance-reducing layer 110 is entirely covered without being exposed from upper electrode layer 11 and piezoelectric layer 9. This structure prevents degradation of the characteristics of capacitance-reducing layer 110 as well as deterioration of the adhesion to piezoelectric layer 9 and upper electrode layer 11.

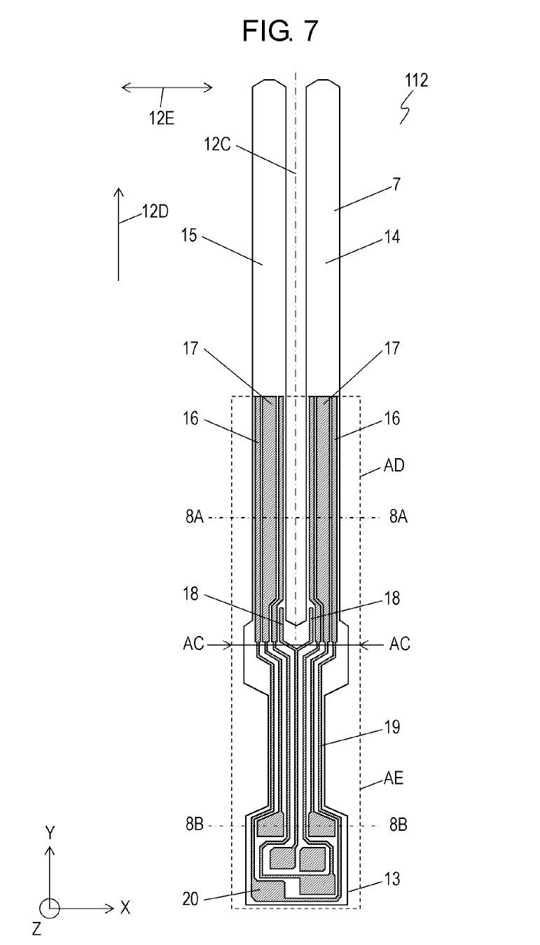

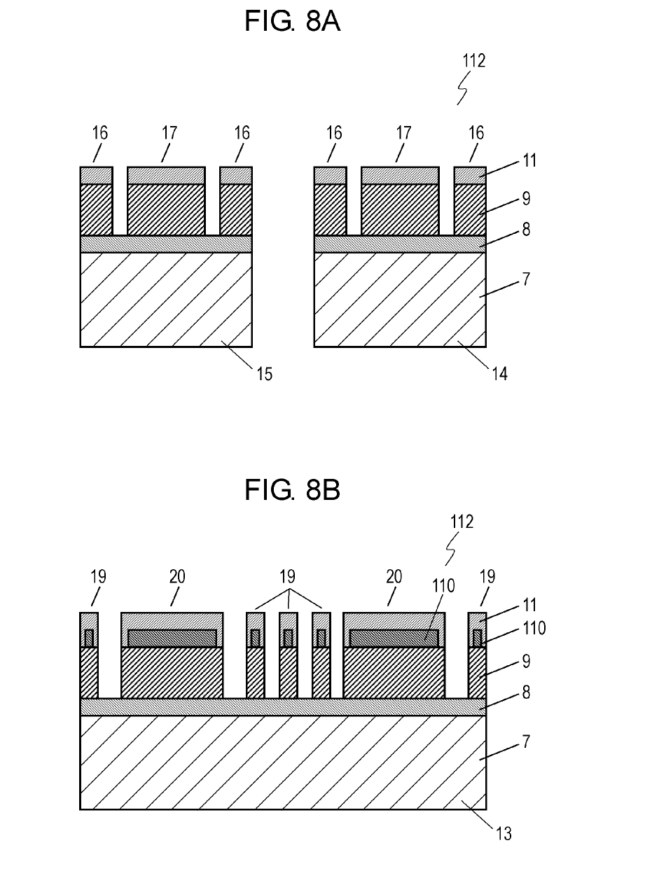

FIG. 7 is a top view of further inertial force sensor 112 according to Embodiment 1. FIG. 8A is a cross-sectional view of inertial force sensor 112 at line 8A-8A shown in FIG. 7. FIG. 8B is a cross-sectional view of inertial force sensor 112 at line 8B-8B shown in FIG. 7. In FIGS. 7, 8A, and 8B, components identical to those of inertial force sensor 12 shown in FIGS. 3, 4A, 4B are denoted by the same reference numerals.

Inertial force sensor 112 shown in FIGS. 7 to 8B includes capacitance-reducing layer 110 shown in FIG. 6 instead of capacitance-reducing layer 10 of inertial force sensor 12 shown in FIGS. 3 to 4B. In other words, wiring traces 19 and electrode pads 20 in region AE include capacitance-reducing layer 110 disposed on the upper surface of piezoelectric layer 9. Upper surface 110A and side surfaces 110C and 110D of capacitance-reducing layer 110 are covered by upper electrode layer 11. Upper electrode layer 11 and piezoelectric layer 9 entirely cover capacitance-reducing layer 110 without exposing capacitance-reducing layer 110. This structure prevents degradation of the characteristics of capacitance-reducing layer 110 as well as deterioration of the adhesion to piezoelectric layer 9 and upper electrode layer 11.

As described in Embodiment 1, inertial force sensor 6 (12, 106, 112, 206) includes substrate 7, transducers (i.e., driving electrode 16, detection electrode 17, and monitor electrode 18) disposed on substrate 7, and wiring traces 19 provided on substrate 7 and connected with the transducers.

Each of wiring traces 19 includes lower electrode layer 8 provided on the upper surface of substrate 7, piezoelectric layer 9 provided on the upper surface of lower electrode layer 8, capacitance-reducing layer 10 (110, 210) having an insulation property provided on the upper surface of piezoelectric layer 9, and upper electrode layer 11 provided on the upper surface of capacitance-reducing layer 10 (110, 210). The relative dielectric constant of capacitance-reducing layer 10 (110, 210) is smaller than the relative dielectric constant of piezoelectric layer 9. Piezoelectric layer 9 and upper electrode layer 11 cover capacitance-reducing layer 110 entirely not to expose capacitance-reducing layer 110.

Capacitance-reducing layer 110 has lower surface 110B situated on upper surface 9A of piezoelectric layer 9. Capacitance-reducing layer 110 further has side surface 110C (110D) connected with upper surface 110A and lower surface 110B. Upper electrode layer 11 covers upper surface 110A and side surface 110C (110D) of capacitance-reducing layer 110.

Each of the transducers (i.e., driving electrode 16, detection electrode 17 and monitor electrode 18) includes lower electrode layer 8 provided on the upper surface of substrate 7, piezoelectric layer 9 provided on the upper surface of lower electrode layer 8, and upper electrode layer 11 provided on the upper surface of piezoelectric layer 9. Lower electrode layer 8 of the transducer extends continuously to lower electrode layer 8 of wiring trace 19. Piezoelectric layer 9 of the transducer extends continuously to piezoelectric layer 9 of wiring trace 19. Upper electrode layer 11 of the transducer also extends continuously to upper electrode layer 11 of wiring trace 19.

The transducer (detection electrode 17) detects a stress produced in substrate 7. Another transducer (driving electrode 16) drives substrate 7 to vibrate substrate 7.

### Exemplary Embodiment 2

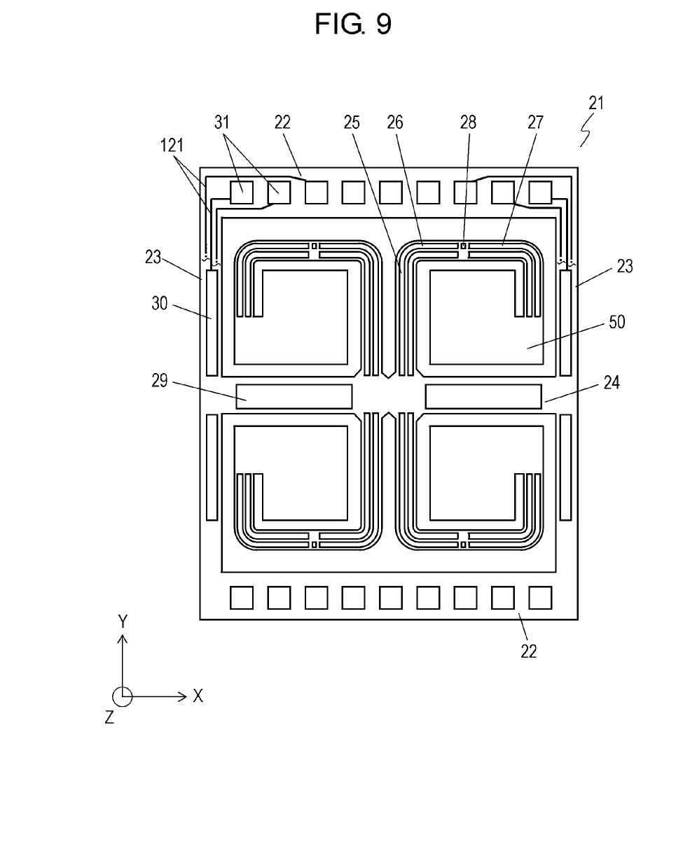

FIG. 9 is a top view of inertial force sensor 21 according to Exemplary Embodiment 2 of the present invention. Inertial force sensor 21 has a shape different from that of inertial force sensor 12 according to Embodiment 1 shown in FIG. 3. As shown in FIG. 9, inertial force sensor 21 includes two support portions 22, two longitudinal beams 23 having both ends connected to two support portions 22, lateral beam 24 having both ends connected to two longitudinal beams 23, arm 25 having a J-shape having one end connected with lateral beam 24, and weight 50 connected with another end of arm 25. Two support portions 22 extend in a direction parallel to the X-axis. Driving electrode 26, detection electrode 27, and monitor electrode 28 are disposed at arm 25. Detection electrode 29 is disposed at lateral beam 24. Detection electrode 30 is disposed at longitudinal beam 23. Electrode pads 31 are provided on support portions 22, and are electrically connected with driving electrode 26, detection electrodes 27, 29 and 30, and monitor electrode 28 via wiring traces 121.

An operation of inertial force sensor 21 will be described below. Driving electrode 26 and monitor electrode 28 are connected with a drive circuit via wiring traces 121 and electrode pads 31. Driving electrode 26, monitor electrode 28, and the drive circuit constitute a driving loop. Arm 25 vibrates in an X-Y plane when a driving signal is supplied from the drive circuit to driving electrode 26 via electrode pad 31 and wiring trace 121. When an angular velocity about the Z-axis is applied under this condition, arm 25 warps in the direction of the Y-axis due to a Coriolis force generated by the angular velocity, and generate an electric charge in detection electrode 27. When an angular velocity about the X-axis is applied under the condition in which arm 25 vibrates in the X-Y plane, arm 25 warps in the direction of the Z-axis due to the Coriolis force generated by the angular velocity, and an electric charge is generated in detection electrode 29. When an angular velocity about the Y-axis is applied under the same condition that arm 25 vibrates in the X-Y plane, arm 25 warps in the direction of the Z-axis due to the Coriolis force generated by the angular velocity, and an electric charge is generated in detection electrode 30. An electric current produced by the electric charge generated in each of detection electrodes 27, 29 and 30 is supplied to the detection circuit via wiring traces 121 and electrode pads 31. The detection circuit can thus detect the angular velocities about the

X-axis, the Y-axis, and the Z-axis based on the supplied current.

In inertial force sensor 21, each of driving electrode 26, detection electrodes 27, 29 and 30, and monitor electrode 28 does not include capacitance-reducing layer 10 shown in FIG. 1A or capacitance-reducing layer 110 shown in FIG. 6. Each of wiring traces 121 and electrode pads 31 includes capacitance-reducing layer 10 or capacitance-reducing layer 110. This structure reduces capacitances of wiring traces 121 and electrode pads 31. In other words, capacitance-reducing layer 10 and capacitance-reducing layer 110 provided in the region that does not constitute characteristics of inertial force sensor 21 can improve a noise level and decrease power consumption of the drive circuit and the detection circuit connected with inertial force sensor 21.

### Exemplary Embodiment 3

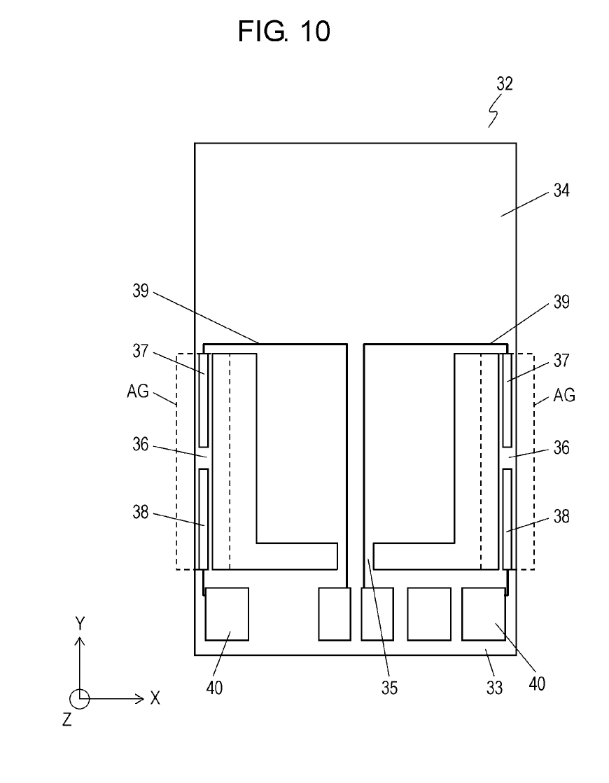

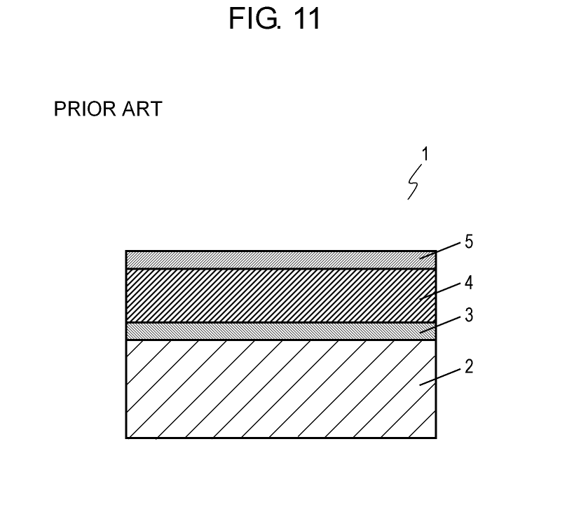

FIG. 10 is a top view of inertial force sensor 32 according to Exemplary Embodiment 3 of the invention. Inertial force sensor 32 functions as an acceleration sensor for detecting acceleration. Inertial force sensor 32 includes support portion 33, weight 34, center support beam 35 connecting support portion 33 with weight 34, and vibration beams 36. Driving electrode 37 and detection electrode 38 are provided on each of vibration beams 36. Driving electrodes 37 and detection electrodes 38 are electrically connected with electrode pads 40 via wiring traces 39.

Inertial force sensor 32 is connected with a drive circuit via driving electrodes 37, so that driving electrodes 37 and the drive circuit constitute a driving loop. Vibration beams 36 vibrate in a direction of the Z-axis when a driving signal is supplied from the drive circuit to driving electrodes 37 via electrode pads 40 and wiring traces 39. When acceleration in a direction of the X-axis is applied under this condition, a tensile stress and a compressive stress are applied to vibration beams 36 located at opposite sides with respect to center support beam 35. The stresses change the resonance frequency of vibration beams 36. This change is detected by detection electrodes 38 disposed on vibration beams 36, and allows the acceleration to be detected. In inertial force sensor 32, driving electrodes 37 and detection electrodes 38 include none of capacitance-reducing layers 10 and 110. The components, such as wiring traces 39 and electrode pads 40, other than driving electrodes 37 and detection electrodes 38 includes capacitance-reducing layer 10 or capacitance-reducing layer 110. This structure reduces capacitances of wiring traces 39 and electrode pads 40. In other words, capacitance-reducing layer 10 and capacitance-reducing layer 110 formed in the region that does not constitute characteristics of inertial force sensor 32 can improve a noise level and decrease power consumption of the drive circuit and a detection circuit connected with inertial force sensor 32.

The inertial force sensors according to Embodiments 1 to 3 function as angular velocity sensors and acceleration sensors. Capacitance-reducing layer 10 or 110 decrease an electrode capacitance of other inertial force sensors, such as pressure sensors, thus improving a noise level and reduce power consumption of circuits connected with the inertial force sensors.

In Embodiments 1 to 3, terms, such as “upper surface” and “lower surface”, indicating directions merely indicate relative directions depending only upon relative positions of structural elements, such as substrate 7 and capacitance-reducing layer 10, of the inertial force sensors, and do not indicate absolute directions, such as a vertical direction.

### INDUSTRIAL APPLICABILITY

The Inertial force sensor according to the present invention can improve noise level, and thus, is useful for portable terminals, automobiles and the like apparatuses since they can improve noise levels.

### REFERENCE MARKS IN THE DRAWINGS

6 Inertial Force Sensor
7 Substrate
8 Lower Electrode Layer (First Lower Electrode Layer, Second Lower Electrode Layer)
9 Piezoelectric Layer (First Piezoelectric Layer, Second Piezoelectric Layer)
10 Capacitance-Reducing Layer
11 Upper Electrode Layer (First Upper Electrode Layer, Second Upper Electrode Layer)
16 Driving Electrode (Transducer)
17 Detection Electrode (Transducer)
18 Monitor Electrode (Transducer)
19 Wiring Trace
110 Capacitance-Reducing Layer

1. An inertial force sensor comprising:
a substrate;
a transducer disposed on the substrate; and
a wiring trace disposed on the substrate and connected with the transducer, the wiring trace including
a first lower electrode layer formed on an upper surface of the substrate,
a first piezoelectric layer provided on an upper surface of the first lower electrode layer,
a capacitance-reducing layer provided on an upper surface of the first piezoelectric layer, and
a first upper electrode layer provided on an upper surface of the capacitance-reducing layer,
wherein the capacitance-reducing layer has a relative dielectric constant smaller than a relative dielectric constant of the first piezoelectric layer,
wherein the capacitance-reducing layer is made of a photosensitive polyimide, and
wherein a curing temperature of the capacitance-reducing layer is lower than a Curie temperature of the first piezoelectric layer.

2. The inertial force sensor of claim 1, wherein the first piezoelectric layer and the first upper electrode layer cover the capacitance-reducing layer completely so as not to expose the capacitance-reducing layer.

3. The inertial force sensor of claim 1,
wherein the capacitance-reducing layer has a lower surface situated on the upper surface of the first piezoelectric layer,
wherein the capacitance-reducing layer has a side surface connected with the upper surface and the lower surface of the capacitance-reducing layer, and
wherein the first upper electrode layer covers the upper surface and the side surface of the capacitance-reducing layer.

4. The inertial force sensor of claim 1, wherein a thickness of the capacitance-reducing layer is not larger than a thickness of the first upper electrode layer.

5. The inertial force sensor of claim 1, wherein a dielectric constant of the capacitance-reducing layer is not larger than 5% of a dielectric constant of the first piezoelectric layer.

6. The inertial force sensor of claim 1, wherein the capacitance-reducing layer is made of a photosensitive organic material.

7. (canceled)

8. The inertial force sensor of claim 1, wherein the capacitance-reducing layer is made of a photosensitive polyimide which can be developed with alkali.

9. (canceled)

10. The inertial force sensor of claim 1, wherein the transducer includes:
a second lower electrode layer provided on the upper surface of the substrate;
a second piezoelectric layer provided on an upper surface of the second lower electrode layer; and
a second upper electrode layer provided on an upper surface of the second piezoelectric layer.

11. The inertial force sensor of claim 10,
wherein the second lower electrode layer extends continuously to the first lower electrode layer,
wherein the second piezoelectric layer extends continuously to the first piezoelectric layer, and
wherein the second upper electrode layer extends continuously to the first upper electrode layer.

12. The inertial force sensor of claim 1, wherein the transducer detects a stress applied to the substrate.

13. The inertial force sensor of claim 1, wherein the transducer drives the substrate to cause the substrate to vibrate.
